(19) United States
(12) Patent Application Publication
(10) Pub. No.: US 2011/0061226 A1
(43) Pub. Date: Mar. 17, 2011

(54) Machine for making preassembled drainage units

(76) Inventors: Harry Bussey, JR., Marco Island, FL (US); Buddy Harry Bussey, III, Atlantic Highlands, NJ (US)

(21) Appl. No.: 12/807,905

(22) Filed: Sep. 16, 2010

Related U.S. Application Data
(60) Provisional application No. 61/276,773, filed on Sep. 16, 2009.

(51) Int. Cl. B23P 19/00

(52) U.S. Cl. 29/700

(57) ABSTRACT

The barrel of a machine for passing a light weight synthetic aggregate into a sleeve of disparate materials, such as netting and geotextile material, has a tongue extending from a portion of the periphery of the terminal end of the barrel to balance the air flow from the barrel and achieve a uniform filling of the sleeve. A ring is also disposed about the end of the barrel to blow jets of air onto the sleeve to block blowback of aggregate between the sleeve and barrel.

This application claims the benefit of Provisional Patent Application 61/276,773 filed Sep. 16, 2009.

The invention relates to improvements in the manufacture of preassembled drainage units and, particularly, drainage units as described in Published Application US2009/0123232 dated May 14, 2009.

As is known, machines for making preassembled drainage units employing light weigh synthetic aggregate generally comprises a chute or barrel for pneumatically blowing a flow of the aggregate into a sleeve of material disposed about the chute or barrel and with a closed end extending from the terminal end of the chute or barrel. In some cases, the sleeve is made of netting while in other cases, the sleeve is made of a geotextile material, such as, a spun bonded non-woven polyester.

During operation of the machines, the sleeve of material is gathered and secured outside the barrel so that upon blowing of the aggregate from the barrel, the aggregate fills the sleeve and pulls the sleeve from the barrel. After a predetermined length of filled sleeve has been blown or pulled off the barrel, continued delivery of the aggregate is stopped and a back end of the sleeve of material is gathered and secured outside the barrel. Thus is formed a preassembled drainage unit and the beginning of a second drainage unit.

It has been found that when the barrel is in a horizontal plane and the sleeves of the drainage units are made with sections of netting and geotextile material, a problem arises in that the drainage units do not fill uniformly to the predetermined length. For example, where the length of a drainage unit is to be 10 feet, these composite drainage units have lengths that vary from 9 feet 8 inches to 10 feet 2 inches.

It has also been found that there is a risk of a blowback of aggregate between the sleeve and barrel during the formation of preassembled drainage units in a machine employing a barrel for pneumatically blowing a flow of the aggregate into the sleeve.

Accordingly, it is an object of the invention to fill a preassembled drainage unit made with a sleeve of netting and geotextile material in an accurate manner.

It is another object of the invention to avoid any blowback of aggregate between a sleeve and a barrel in a machine employing a barrel for pneumatically blowing a flow of the aggregate into the sleeve.

It is another object of the invention to be able to form multiple preassembled drainage units of accurate lengths in a repeatable manner.

Briefly, the invention is directed to a machine for making preassembled drainage units that are formed of a mass of discrete lightweight synthetic aggregate within a sleeve having sections of disparate material, such as, a sleeve having a first peripheral portion of a water permeable filter material, such as a geotextile material, and a second peripheral portion of net material having openings for retaining the aggregate and allowing the passage of water.

The machine employs a horizontally disposed barrel over which the sleeve passes and through which a light weight synthetic aggregate-laden air stream passes. In accordance with the invention, the barrel is characterized in having a tongue that extends longitudinally from a terminal end of the barrel and that is of a complementary shape to the barrel to extend over at least a portion of the periphery of the barrel. Where the barrel is cylindrical, the tongue has an arcuate shape.

During operation of the machine, a light weight synthetic aggregate-laden air stream is passed through the barrel and out the terminal end of the barrel into a sleeve of the disparate materials. Generally, the air passing from the barrel is blocked from entering the aggregate filled part of the sleeve by the aggregate and, instead, deflects to move transversely through the sleeve within a gap that develops between the terminal end of the barrel and the aggregate filled part of the sleeve. Because one peripheral portion of the sleeve is made of a material having a different porosity than another peripheral portion, the flow of air through each peripheral portion is different. For example, where the peripheral portion is made of net material, the flow of air is substantially unimpeded. However, where the peripheral portion is made of water permeable filter material, the flow of air is impeded and slowed. The resulting imbalance in the air flow exiting from the barrel and through the sleeve causes a variance in the amount of aggregate delivered into a sleeve. For example, for a nominal 10 foot preassembled drainage unit, the drainage unit may have a length that varies from 9 feet 8 inches to 10 feet 2 inches.

Positioning the tongue so that the peripheral portion of the sleeve having the higher porosity, i.e. the net material, moves over the tongue, restricts the air from exiting transversely through the net material and past the tongue.

It has been discovered that by adding a tongue to the end of the barrel on the side of the netting to restrict the air flow through the aggregate and the netting, the filling of the composite sleeve becomes uniform and accurate. The addition of the tongue is believed to restrict the air flow from the barrel through the netting to the amount of air flow from the barrel through the geotextile material thereby balancing the air flow from the barrel and creating a uniform filling of the composite sleeve with aggregate.

The tongue may be adjustable relative to the barrel and may be provided with holes or slits to regulate the air escaping through the netting to equal the air escaping through the geotextile material.

In order to avoid a blowback of aggregate between the sleeve and barrel during the formation of preassembled drainage units, the invention also provides the machine with a ring that is disposed concentrically of the terminal end of the barrel to define a gap therebetween for passage of a moving sleeve of material therethrough during passage of the light weight synthetic aggregate-laden air stream from the barrel. This ring may be used with or without the tongue. In addition, the ring is hollow and has a plurality of circumferentially disposed ports directed towards the terminal end of the barrel and a supply of air is delivered to the ring for passage through the ports.

During operation of the machine, the ring confines the size of the annular space formed between the barrel and the sleeve at the terminal end of the barrel. In addition, a flow of air is delivered to the ring for passage out of the ports and towards the terminal end of the barrel. In this respect, the flows of air from the ports gently press the sleeve radially inwardly toward and against the barrel to block any blowback of aggregate between the sleeve and barrel.

These and other objects and advantages of the invention will become more apparent from the following detailed description taken in conjunction with the accompanying drawings wherein:

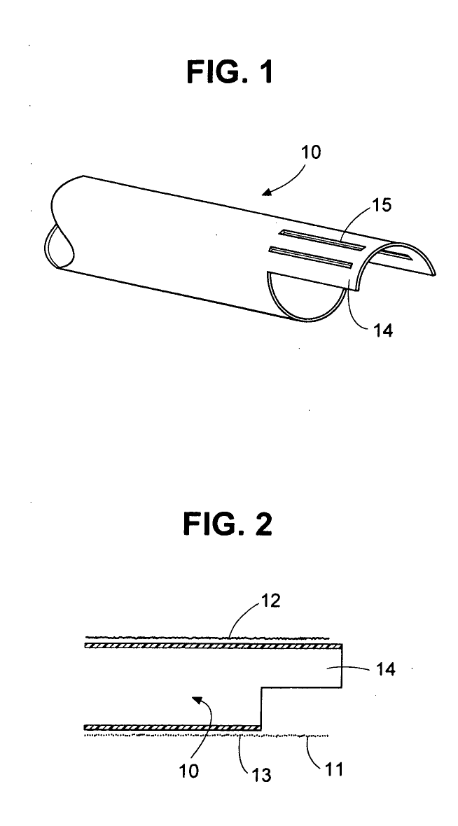

FIG. 1 illustrates a perspective view of a terminal end of a barrel in accordance with the invention;

FIG. 2 illustrates a part cross-sectional view of the barrel of FIG. 1 during use in a machine for making preassembled drainage units;

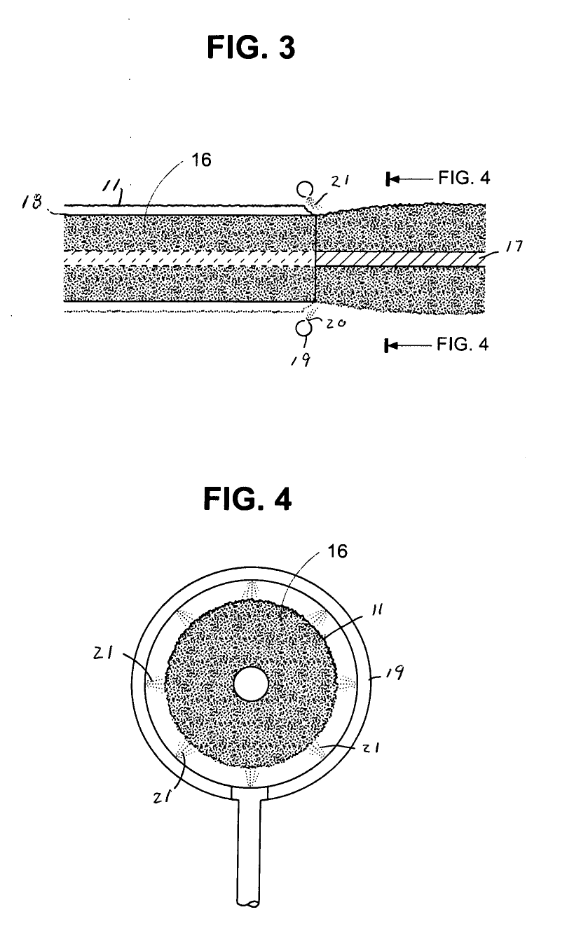

FIG. 3 illustrates a part cross-sectional view of a ring disposed concentrically of the end of a barrel to supply a flow of air onto a sleeve moving off the end of the barrel in accordance with the invention; and

FIG. 4 illustrates an end view of the structures of FIG. 3.

Referring to FIGS. 1 and 2, the barrel 10 forms an end of a machine for making preassembled drainage line units, such as described in published US 2007/0081859 and 2009/0123232, and is disposed in a horizontal plane. The machine includes means (not shown) about the barrel 10 for shaping at least two continuously supplied strips of material into a tubular shape about the barrel 10 with the longitudinal edges thereof in overlapping relation; and means to seal the longitudinal edges of the material strips together to form a tube.

By way of example, the barrel 10 has a 10 inch outside diameter for making drainage units of 10 inch diameter. Any other diameter of the barrel 10 is also suitable. In addition, the barrel 10 may be oval in cross-section to form preassembled drainage line units of oval cross-sectional shape.

The drainage units are made with a composite sleeve or tube 11 made from disparate materials, such as, a strip of netting 12 and a strip of geotextile material 13. In the example, one half of the composite sleeve 11 is made of netting and one half is made of geotextile material. However, the composite sleeve 11 may be made with sections of netting and sections of geotextile material of different proportions and positioning.

A tongue 14 extends longitudinally from a terminal end of the barrel 10 and is of a complementary shape to the barrel 10 to extend over at least a portion of the periphery of the barrel 10. For example, the tongue 14 may be integral with the remainder of the barrel 10. In this case, the end of the barrel may be cut to form the tongue 14 or a separate element may be welded to the barrel 10 to form the tongue 14.

The use of a separate element to form the tongue not only allows the peripheral extent of the tongue to be adjusted relative to the diameter of the barrel 10 but also allows the longitudinal length of the tongue to be adapted to the drainage units being made.

Alternatively, the tongue 14 may be a separate element that is mounted on the barrel 10 in an adjustable manner so as to be moved backwards or forwards relative to the terminal end of the barrel 10.

The tongue 14 has an arcuate shape to extend over 180° of the circumference of the barrel 10. In this respect, the circumferential extent of the tongue 14 relative to the barrel 10 is equal to the circumferential extent of the strip of netting 12.

The tongue 14 may be provided with holes or slits 15, as shown in FIG. 1, to regulate the air escaping through the netting 12 to equal the air escaping through the geotextile material 13.

During operation of the machine, a light weight synthetic aggregate-laden air stream is passed through the barrel 10 and out the terminal end of the barrel 10 into the sleeve 11 of disparate materials. Generally, the air passing from the barrel 10 is blocked from entering the aggregate filled part of the sleeve 11 by the aggregate 16 and, instead, deflects to move transversely through sleeve 11 within a gap that develops between the terminal end of the barrel 10 and the aggregate filled part of the sleeve 11. Because the peripheral portion 12 of the sleeve 11 is made of a netting material having a higher porosity than the other peripheral portion 13 made of geotextile material, the flow of air through each peripheral portion is different. For example, the flow of air is substantially unimpeded through the netting 12 while being is impeded and slowed through the geotextile material.

Positioning the tongue 14 so that the net material 12 moves over the tongue 14, restricts the air from exiting transversely through the net material 12 and past the tongue 14. As a result, the filling of the composite sleeve 11 becomes uniform and accurate.

Referring to FIGS. 3 and 4, the machine for making a preassembled drainage unit comprised of a sleeve 11, light weight synthetic aggregate 16 and an elongated element 17, such as a rope, as shown, or a corrugated perforated pipe or other elongated element as described in U.S. Pat. No. 7,600,308 is provided with a barrel 18 that may or may not have a tongue as described above. As illustrated, the barrel 18 is horizontally disposed so that the aggregate 16 is blown horizontally out of the terminal end of the barrel 18 to fill the sleeve 11. The sleeve 11 need not be made from disparate materials, as above, but may also be made solely of netting or solely of geotextile material.

In this embodiment, In order to avoid a blowback of aggregate 16 between the sleeve 11 and the barrel 18 during the formation of the preassembled drainage units, a ring 19 is disposed concentrically of the terminal end of the barrel 18 to define a gap therebetween for passage of the moving sleeve 11 therethrough during passage of the light weight synthetic aggregate 16 from the barrel 18. Where the barrel has a predetermined diameter at the terminal end, the gap between the barrel 18 and the ring 19 is annular.

As indicated in FIG. 3, the ring 19 is hollow and has a plurality of circumferentially disposed ports 20 directed towards the terminal end of the barrel 18, for example, at a slight angle from a perpendicular to the barrel 18. During operation, a supply of air is delivered to the ring 19 from a suitable source for distribution through the ports 20 in the form of individual jets of air 21, each of which is directed in the direction of movement of the sleeve 11 and against the terminal end of the barrel 18.

During operation of the machine, the ring 19 confines the size of the annular space formed between the sleeve 11 and the terminal end of the barrel 18. In addition, the jets of air 21 from the ports 20 gently press the sleeve 11 radially inwardly toward and against the barrel 19 to block any blowback of aggregate 16 between the sleeve 11 and barrel 19.

The invention thus provides a machine for filling a preassembled drainage unit made with a sleeve of netting and geotextile material in an accurate manner and for forming multiple preassembled drainage units of accurate lengths in a repeatable manner.

The invention also provides a technique for avoiding any blowback of aggregate between a sleeve and a barrel in a machine employing a barrel for pneumatically blowing a flow of the aggregate into the sleeve.

What is claimed is:

1. In a machine for making drainage units, the combination comprising
a horizontally disposed barrel for passage of a light weight synthetic aggregate-laden air stream therethrough; and
a tongue extending longitudinally from a terminal end of said barrel and being of a complementary shape to said barrel to extend over at least a portion of the periphery of said barrel.

2. In a machine as set forth in claim 1 wherein said barrel has a predetermined diameter and said tongue has an arcuate shape.

3. In a machine as set forth in claim 1 wherein said tongue is integral with said barrel.

4. In a machine as set forth in claim 1 wherein said tongue is removably mounted on said barrel.

5. In a machine as set forth in claim 1 wherein said tongue has a plurality of holes to regulate the passage of air from said barrel through said tongue.

6. In a machine as set forth in claim 1 further comprising a ring disposed concentrically of said terminal end of said barrel and defining a gap therebetween for passage of a moving sleeve of material therethrough during passage of the light weight synthetic aggregate-laden air stream from said barrel.

7. In a machine as set forth in claim 6 wherein said barrel has a predetermined diameter at said terminal end and said gap between said barrel and said ring is annular.

8. In a machine for making drainage units, the combination comprising
a horizontally disposed barrel for passage of a light weight synthetic aggregate-laden air stream therethrough; and
a ring disposed concentrically of a terminal end of said barrel and defining a gap therebetween for passage of a moving sleeve of material therethrough during passage of the light weight synthetic aggregate-laden air stream from said barrel.

9. In a machine as set forth in claim 8 wherein said barrel has a predetermined diameter at said terminal end and said gap between said barrel and said ring is annular.

10. In a machine as set forth in claim 8 wherein said ring is hollow and has a plurality of circumferentially disposed ports directed towards said terminal end of said barrel and wherein a supply of air is delivered to said ring for passage through said ports.
